(19) United States
(12) Patent Application Publication
(10) Pub. No.: US 2025/0314833 A1
(43) Pub. Date: Oct. 9, 2025

(54) OPTICAL DEVICE WITH CLOSED LOOP FEEDBACK

(71) Applicant: Lumentum Operations LLC, San Jose, CA (US)

(72) Inventors: Shane H. WOODSIDE, Ottawa (CA); Sheldon MCLAUGHLIN, Ottawa (CA); Yi LIANG, Ottawa (CA); Thomas HASLAM, Ottawa (CA); Philip DUGGAN, Ottawa (CA)

(21) Appl. No.: 18/613,003

(22) Filed: Mar. 21, 2024

Related U.S. Application Data
(60) Provisional application No. 63/589,152, filed on Oct. 10, 2023.

(51) Int. Cl. G02B 6/35

(52) U.S. Cl. CPC G02B 6/3588; G02B 6/352; G02B 6/3546; G02B 6/3518; G02B 6/3578; G02B 6/3584

(57) ABSTRACT

An optical device may include a set of signal inputs, a set of pilot path inputs, a set of signal outputs, and a set of pilot path outputs. A pilot path output may be coupled to a pilot path input to form a pilot path. The optical device may include a set of elements on the pilot path and on a set of signal paths formed among the set of signal inputs and the set of signal outputs. The optical device may include a photodiode to convert a pilot signal on the pilot path output to an electrical signal, and a controller to selectively adjust one or more elements based at least in part on the electrical signal to compensate for a difference in a current state associated with the set of elements relative to an original state associated with the set of elements.

### CROSS-REFERENCE TO RELATED APPLICATION

This patent application claims priority to U.S. Provisional Patent Application No. 63/589,152, filed on Oct. 10, 2023, and entitled “OPTICAL SWITCH WITH CLOSED LOOP FEEDBACK.” The disclosure of the prior Application is considered part of and is incorporated by reference into this patent application.

### TECHNICAL FIELD

The present disclosure relates generally to an optical device and to an optical device with closed loop feedback.

### BACKGROUND

Optical space switching in telecommunications applications is known as an alternative to as pure wavelength switching. Gains in transmission efficiency in the C-band and the L-band have been driven mainly via spectral efficiency (e.g., number of bits per gigahertz (GHz) of spectrum), but transmission systems will eventually reach Shannon's limit. Therefore, increasing per-channel capacity will require widened spectrum, and as this continues, eventually optical fiber switching will augment and/or replace wavelength switching in some optical systems. Hence, fiber switching will be utilized in telecommunications applications.

A need for efficient, transparent, and reliable optical M×N switches also exists in a datacenter application to, for example, support intra-datacenter communication. Some advantages of optical switching in such an application include reduced operating costs, reduced power consumption, improved ability to upgrade and operate mixed modes (e.g., 100 gigabits per second (G)/200 G/400 G), reduced latency from implementation using an optical (transparent) M×N switch architecture (rather than a conventional spine or a leaf and spine architecture), and other details with respect to implementation of a specific optical M×N implementation. The datacenter application is a significant and looming need for efficient optical transparent M×N solutions, particularly as datacenter operators seek efficiencies as build-outs for burgeoning artificial intelligence (AI) and machine learning (ML) applications take place.

### SUMMARY

In some implementations, an optical device includes a set of M (M≥1) signal inputs; a set of K (K≥1) pilot path inputs, wherein a light source is coupled to a pilot path input in the set of K pilot path inputs; a set of N (N≥1) signal outputs; a set of L (L≥1) pilot path outputs, wherein a pilot path output in the set of L pilot path outputs is coupled to the pilot path input to form a pilot path; a set of elements, the set of elements being on the pilot path and on a set of signal paths formed among the set of M signal inputs and the set of N signal outputs, wherein at least one element in the set of elements is adjustable to influence coupling of optical beams among inputs and outputs of the optical device; a photodiode coupled to the pilot path output to convert a pilot signal on the pilot path output to an electrical signal; and a controller to selectively adjust one or more elements of the set of elements based on a relationship between the electrical signal and the selective adjustment, wherein the adjustment is to compensate for a difference in a current state associated with the set of elements relative to an original state associated with the set of elements.

In some implementations, an optical device includes a set of M (M≥1) signal inputs; a set of K (K≥1) pilot path inputs, wherein a light source is coupled to a pilot path input in the set of K pilot path inputs; a set of N (N≥1) signal outputs; a set of L (L≥1) pilot path outputs, wherein a pilot path output in the set of L pilot path outputs is coupled to the pilot path input to form a pilot path; a set of elements on the pilot path and on a set of signal paths formed among the set of M signal inputs and the set of N signal outputs; a photodiode coupled to the pilot path output; and a controller to provide compensation for the set of signal paths based at least in part on a pilot signal that traverses the pilot path, wherein the compensation is to account for a difference in a current state of the set of elements relative to a previous state of the set of elements.

In some implementations, a method includes monitoring, by a controller of an optical device, a strength of a pilot signal on a pilot path of the optical device, wherein the pilot path is defined by a pilot path input and a pilot path output; detecting, by the controller and based on monitoring the strength of the pilot signal, a trigger to perform a loss optimization associated with the pilot path; adjusting, by the controller, a set of elements on the pilot path to influence coupling of the pilot signal at the pilot path input and at the pilot path output, wherein the set of elements is adjusted to reduce loss of the pilot signal on the pilot path; storing, by the controller, positional information associated with the set of elements on pilot path after the adjustment of the set of elements on pilot path; determining, by the controller and based on the positional information, a positional change of the set of elements on pilot path after the adjustment of the set of elements on pilot path; determining, by the controller, a correlation between the positional change of the set of elements on pilot path and an expected positional change of one or more elements on a signal path; and compensating, by the controller, for an expected drift effect based on the correlation.

### BRIEF DESCRIPTION OF THE DRAWINGS

FIG. 1 is a diagram illustrating an example implementation of an optical device with closed loop feedback described herein.

FIG. 2 is a flow chart illustrating an example process associated with calibrating the optical device described herein.

FIG. 3 is a flow chart illustrating an example process associated with providing drift compensation for the optical device described herein.

FIG. 4 is a diagram of example components of a device associated with the optical device with closed loop feedback described herein.

### DETAILED DESCRIPTION

The following detailed description of example implementations refers to the accompanying drawings. The same reference numbers in different drawings may identify the same or similar elements.

An ideal M×N optical switch is truly transparent, meaning that the M×N optical switch is able to configure each of the M inputs to each of the N outputs without adding any loss. Low insertion loss is particularly important in some applications, such as an intra-datacenter application, due to a need to maximize transmission bandwidth using already-standardized transceivers (with a limited insertion loss (IL) budget). Even if non-standard transceivers are used, for any given transmission capacity, higher losses in an optical switch will require higher power transmit lasers and, thus, will require higher power dissipation and additional cooling. Notably, while illustrated in the context of an intra-datacenter application, these factors and beneficial attributes apply broadly to other applications. Further, the ideal M×N optical switch is highly reliable over a deployment life of the M×N optical switch (e.g., particularly for the intra-datacenter and telecommunication applications).

Some implementations described herein provide an optical device (e.g., an M×N optical switch) with closed loop control that enables steering paths within the optical device to be adjusted over time (e.g., to account for drift effects, such as drift due to aging, drift due to temperature change, or the like). In some implementations, the optical device includes a set of M (M≥1) signal inputs and a set of K (K≥1) pilot path inputs, with a light source being coupled to a pilot path input in the set of K pilot path inputs. The optical device further includes a set of N (N≥1) signal outputs and a set of L (L≥1) pilot path outputs, with a pilot path output in the set of L pilot path outputs being coupled to a pilot path input to form a pilot path. The optical device further includes a set of elements on the pilot path, with the set of elements also being on a set of signal paths formed among the set of M signal inputs and the set of N signal outputs. Here, at least one element in the set of elements is adjustable to influence coupling of optical beams among inputs and outputs of the optical device. The optical device further includes a photodiode coupled to the pilot path output to convert a pilot signal on the pilot path output to an electrical signal, and a controller to selectively adjust one or more elements of the set of elements based on a relationship between the electrical signal and the selective adjustment. In some implementations, the adjustment is to compensate for a difference in a current state of the set of elements relative to an original state of the set of elements.

In some implementations, the closed loop control provided for the optical device described herein enables the optical device to achieve high reliability. Further, in some implementations, the closed loop control serves to reduce or eliminate an impact of drift effects, such as aging effects (e.g., bulk optical alignment shifts), with respect to operation of the optical device. As described herein, the closed loop control is provided in the optical device without introducing elements into signal paths of the optical device, thereby avoiding the addition of loss or other impairments and, therefore, avoiding increased cost factors to scale (e.g., as the quantity of M+N ports scales). In some implementations, the optical device with the closed loop control may be, for example, a two-dimensional (2D) micro-electromechanical systems (MEMS)-based M×N optical switch. Notably, while examples described herein are described in the context of a 2D MEMS-based M×N optical switch, the optical device with the closed loop control may be another type of optical device, such as another type of M×N optical switch or, more generally, any optical device with at least one signal input coupled to at least one signal output.

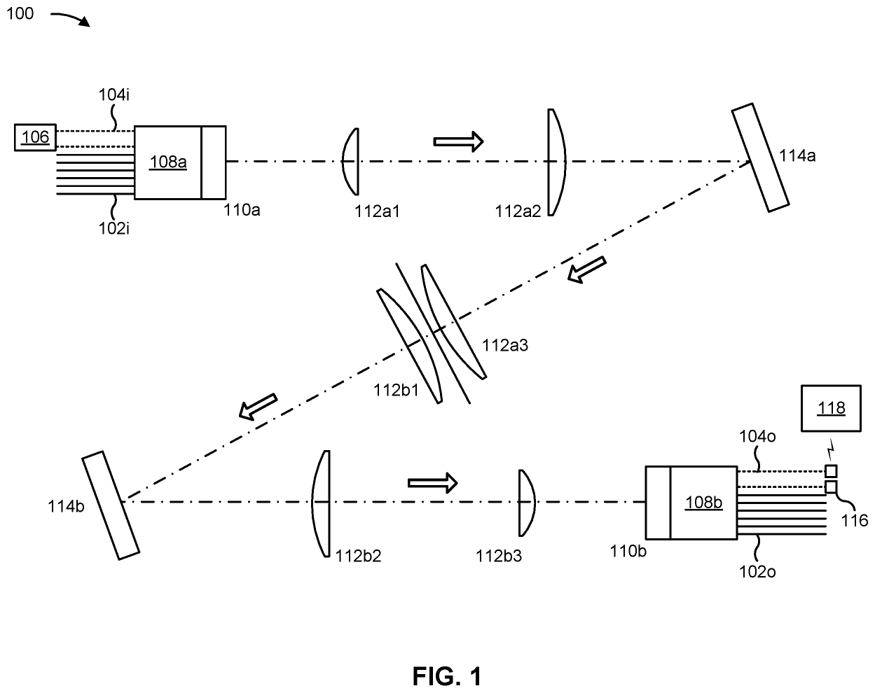

FIG. 1 is a diagram illustrating an example implementation of an optical device 100 with closed loop feedback described herein. As shown in FIG. 1, the optical device 100 includes a set of M (M≥1) signal inputs 102i, a set of N (N≥1) signal outputs 102o, a set of K (K≥1) pilot path inputs 104i, a set of L (L≥1) pilot path outputs 104o, a light source 106, a first fiber array unit (FAU) 108a, a second FAU 108b, a first microlens array (MLA) 110a, a second MLA 110b, a first set of lenses 112a (e.g., lenses 112al through 112a3), a second set of lenses 112b (e.g., lenses 112b1 through 112b3), a first array of beam steering elements 114a, a second array of beam steering elements 114b, one or more photodiodes 116, and a controller 118.

The set of M signal inputs 102i comprises M inputs via which the optical device 100 can receive input optical signals, while the set of N signal outputs 102o comprises N outputs via which the optical device 100 can provide output optical signals (e.g., after switching). In some implementations, a given one of the M signal inputs 102i can be coupled to any of the N signal outputs 102o by configuration of a beam steering element in the first array of beam steering elements 114a and/or configuration of a beam steering element in the second array of beam steering elements 114b. That is, in some implementations, an input optical signal received at any of the M signal inputs 102i inputs can be coupled to any of the N signal outputs 102o and provided as an output optical signal through steering provided by the first array of beam steering elements 114a and the second array of beam steering elements 114b.

A path between a signal input 102i and a signal output 102o is herein referred to as a signal path. In some implementations, an input optical signal received via a signal input 102i (to be provided as an output optical signal via a signal output 102o) is a data-carrying optical signal (i.e., an optical signal modulated to carry data).

The set of K pilot path inputs 104i comprises K inputs via which the optical device 100 can receive input pilot signals, while the set of L signal pilot path outputs 104o comprises L outputs via which the optical device 100 can provide output pilot signals (e.g., after switching). In some implementations, a given one of the K pilot path inputs 104i can be coupled to any of the L pilot path outputs 104o by configuration of a beam steering element in the first array of beam steering elements 114a and/or configuration of a beam steering element in the second array of beam steering elements 114b. That is, in some implementations, a pilot signal received at any of the K pilot path inputs 104i can be coupled to any of the L pilot path outputs 104o through steering provided by the first array of beam steering elements 114a and the second array of beam steering elements 114b. In some implementations, the set of K pilot path inputs 104i inputs includes multiple (i.e., at least two pilot path inputs 104i) and the set of L pilot path outputs 104o includes multiple (i.e., at least two pilot path outputs 104o) such that the set of K pilot path inputs 104i and the set of L pilot path outputs 104o are configurable to form multiple pilot paths. In some implementations, as described below, the controller 118 may be capable of adjusting one or more elements of the optical device 100 based on pilot signals associated with the multiple pilot paths formed among the set of K pilot path inputs 104i and the set of L pilot path outputs 104o. In some implementations, mapping among pilot path inputs 104i and pilot path outputs 104o may be dynamic. For example, the first array of beam steering elements 114a and the second array of beam steering elements 114b may in some implementations be configured such that any of the K pilot path inputs 104i can be coupled to any of the of the L pilot path outputs 104o in order to provide dynamic configuration of pilot paths of the optical device 100. In some implementations, such dynamic mapping enables measurements of shifts at different settings of one or more adjustable elements of the optical device 100 for a compensation algorithm that corrects for drift mechanisms that are dependent on a characteristic of the one or more elements (e.g., mirror angles of one or more beam steering elements in the first array of beam steering elements 114a and/or the second array of beam steering elements 114b). Additionally, or alternatively, mapping among pilot path inputs 104i and pilot path outputs 104o may be static. For example, the first array of beam steering elements 114a and the second array of beam steering elements 114b may in some implementations be configured such that each pilot path input 104i is always coupled to a respective particular pilot path output 104o in order to provide static configuration of pilot paths of the optical device 100.

A path between a pilot path input 104i and a pilot path output 104o on which a pilot signal can be provided is herein referred to as a pilot path. In some implementations, a pilot signal is a signal that can be used for closed loop control. For example, a strength of a pilot signal on a pilot path may be monitored in association with providing closed loop control that provides compensation for a drift effect, as described herein. In some implementations, an input pilot signal received via a pilot path input 104i (to be provided as an output pilot signal via a pilot path output 104o after traversing a pilot path) does not carry data. In some implementations, as shown in FIG. 1, each pilot path input 104i is coupled to a light source 106 that provides pilot path signals.

The light source 106 is a light source (e.g., a laser) to provide pilot path signals to the pilot path inputs 104i. In some implementations, as shown in FIG. 1, the optical device 100 may include a single light source 106 that is coupled to each of the pilot path inputs 104i. Additionally, or alternatively, the optical device 100 may include multiple light sources 106, each of which is coupled to one or more pilot path inputs 104i in the set of K pilot path inputs 104i. In some implementations, one or more light sources 106 may be included in the optical device 100 (e.g., one or more light sources 106 may be internal to the optical device 100). Additionally, or alternatively, one or more light sources 106 may be separate from the optical device 100 (e.g., one or more light sources 106 may be external to the optical device 100). In some implementations, a given light source 106 may be continuous wave (CW) laser.

A first FAU 108 is an element comprising a fiber array to couple input optical signals and input pilot signals to the optical device 100 or to couple optical signals and pilot signals from the optical device 100. For example, the first FAU 108a may be an input FAU that couples input optical signals (e.g., data-carrying optical signals) provided via one or more input optical fibers of the optical device 100 and couples input pilot signals (e.g., non-data-carrying light) provided by the light source 106 to the optical device 100. Further, the second FAU 108b may be an output FAU that couples output optical signals to one or more output optical fibers of the optical device 100 and couples output pilot signals to the one or more photodiodes 116. In some implementations, the FAU 108 (e.g., the first FAU 108a, the second FAU 108b) may comprise a one-dimensional (1D) array or may comprise a 2D array.

An MLA 110 is an element comprising an array of micro-lenses to collimate light propagating through the optical device 100. For example, the first MLA 110a may collimate the input optical signals provided by the first FAU 108a and the input pilot signals provided by the light source 106, while the second MLA 110b may focus the output optical signals to be provided to the second FAU 108b and the output pilot signals to be provided to the photodiodes 116. In some implementations, the spacing and arrangement of micro-lenses in the first MLA 110a matches a spacing and arrangement of optical fibers in the first FAU 108a (e.g., such that each optical fiber in the first FAU 108a provides light to a respective micro-lens in the first MLA 110a on a one-to-one basis). Similarly, the spacing and arrangement of micro-lenses in the second MLA 110b may match a spacing and arrangement of optical fibers in the second FAU 108b (e.g., such that each optical fiber in the second FAU 108b receives light from a respective micro-lens in the second MLA 110b on a one-to-one basis).

In some implementations, a FAU 108 and/or an MLA 110 may include an element that is adjustable so as to influence coupling of optical beams among inputs and outputs of the optical device 100. For example, a FAU 108 and/or an MLA 110 may comprise a piezoelectric device (e.g., a piezoelectric actuator), a transducer (e.g., a piezoelectric transducer, a thermal transducer, or the like), or another type of element that functions to steer or otherwise direct an optical beam at the FAU 108/MLA 110.

A lens 112 is an element (e.g., a transparent medium, such as optical glass or polymer) to modify a wavefront curvature of an optical beam (e.g., an optical signal, a pilot signal, or the like) incident on a surface of the lens 112. In some implementations, the lens 112 may include one or more curved surfaces. In some implementations, the lens 112 may be arranged so as to collimate, focus or defocus light through modification of the wavefront curvature provided by the lens 112. For example, in some implementations, in the optical device 100, the lens 112b1 may serve as a focusing lens that converts collimated optical beams into optical beams having wavefronts that are curved such that the optical beams converge. As another example, in the optical device 100, the lens 112a3 may serve as a collimating lens that converts diverging optical beams into collimated optical beams. In some implementations, the lens 112 may comprise one or more concave surfaces or one or more convex surfaces. In some implementations, one or more lenses 112 may serve to provide imaging in the optical device 100. For example, in the optical device 100, the lens 112al and the lens 112a2 may be used to image optical beams (e.g., an optical signal, a pilot signal) at a plane of the first MLA 110a to a plane of the first array of beam steering elements 114a. Similarly, the lens 112b2 and the lens 112b3 may be used to image optical beams at a plane of the second array of beam steering elements 114b to a plane of the second MLA 110b. Notably, while the optical device 100 is illustrated as included lenses 112, the optical device 100 may include other, additional, or different elements that provide similar functionality as that provided by lenses 112, such as one or more curved mirrors, diffractive elements, or other types of elements.

An array of beam steering elements 114 comprises an array of adjustable elements to direct (i.e., steer) optical beams (e.g., optical signals on optical paths, pilot signals on pilot paths) within the optical device 100. For example, the first array of beam steering elements 114a may comprise an array of beam steering elements associated with directing optical beams toward the second array of beam steering elements 114b. In some implementations, the first array of beam steering elements 114a and/or the second array of beam steering elements 114b comprise multiple independent beam steering elements to direct optical beams independently. That is, each of the first array of beam steering elements 114a and the second array of beam steering elements 114b may comprise multiple independent beam steering elements to direct optical beams independently. In some implementations, the array of beam steering elements 114 (e.g., the first array of beam steering elements 114a, the second array of beam steering elements 114b) may comprise a 1D array or may comprise a 2D array. In some implementations, the array of beam steering elements 114 may comprise, for example, a MEMS device (e.g., an array of tiltable mirrors), or a liquid crystal on silicon (LCOS) device (e.g., an array of LCOS panels). In some implementations, the array of beam steering elements 114 may include a piezoelectric device (e.g., a piezoelectric actuator that moves a particular beam steering element of the array of beam steering elements 114 in association with directing an optical beam incident thereon), a transducer (e.g., a piezoelectric transducer, a thermal transducer, or the like) or another type of element that functions to steer or otherwise direct an optical beam incident on the array of beam steering elements 114. In some implementations, a given one of the M signal inputs 102i can be coupled to a given one of the N signal outputs 102o to form a signal path by configuration of appropriate beam steering elements in the first array of beam steering elements 114a and the second array of beam steering elements 114b. Similarly, a given one of the K pilot path inputs 104i can be coupled to a given one of the L pilot path outputs 104o to form a pilot path by configuration of appropriate beam steering elements in the first array of beam steering elements 114a and the second array of beam steering elements 114b.

The photodiode 116 is an element to convert a pilot signal on a pilot path to an electrical signal. In some implementations, a photodiode 116 is coupled to a pilot path output 104o. Thus, in some implementations, a given photodiode 116 receives a pilot signal that has traversed a pilot path and converts the pilot signal to an electrical signal. In some implementations, as shown in FIG. 1, the optical device 100 may include multiple photodiodes 116, each of which is coupled to one or more pilot path outputs 104o in the set of L pilot path outputs 104o. In some implementations, one or more photodiodes 116 may be included in the optical device 100 (e.g., one or more photodiodes 116 may be internal to the optical device 100). Additionally, or alternatively, one or more photodiodes 116 may be separate from the optical device 100 (e.g., one or more photodiodes 116 may be external to the optical device 100). In some implementations, the photodiode 116 may provide an electrical signal generated from the pilot signal to the controller 118.

The controller 118 is a controller to provide closed loop control for the optical device 100 as described herein. For example, the controller 118 may include one or more components to selectively adjust one or more elements of the optical device 100 in association with compensating for a difference in a current state associated with elements of the optical device 100 relative to an original state (e.g., a state at calibration) associated with the elements of the optical device 100. Here, by adjusting for the change in state associated with the elements, the selective adjustment may provide compensation for an impact of the difference in state of the elements on signal paths formed among the set of M signal inputs 102i and the N set of signal outputs 102o. In some implementations, the selective adjustment comprises an adjustment to one or more elements of the optical device 100 so as to influence coupling of optical beams among inputs and outputs of the optical device 100. For example, the selective adjustment may in some implementations comprise an adjustment to one or more beam steering elements in the first array of beam steering elements 114a or an adjustment to one or more beam steering elements in the second array of beam steering elements 114b. As another example, the selective adjustment may include an adjustment to one or more piezoelectric devices of the optical device 100 (e.g., a piezoelectric device included in a FAU 108, a piezoelectric device included in an MLA 108, a piezoelectric device attached to a beam steering element in an array of beam steering elements 114, or the like). In some implementations, the selective adjustment may comprise refraining from adjusting any elements (e.g., when the controller 118 determines that no compensation is needed). In some implementations, the controller 118 performs the selective adjustment based at least in part on an electrical signal provided by the photodiode 116. Additional details regarding closed loop control performed by the controller 118 are provided below.

In some implementations, closed loop control is implemented in the optical device 100 using one or more pilot paths formed among the set of K pilot path inputs 104i and the set of L pilot path outputs 104o (e.g., with each of the one or more pilot paths being coupled to one or more light sources 106 and to a respective photodiode 116). In some implementations, the one or more pilot paths are aligned and calibrated at a start of life of the optical device 100 (e.g., in the same fashion that the signal paths are aligned and calibrated), with all paths being optimally aligned at the start of life of the optical device 100.

In practice, to the extent that any one or more elements in a set of elements of the optical device 100 shift due to some drift effect (e.g., an aging effect, a temperature effect, or the like), one or more pilot paths can be realigned by, for example, adjusting at least one element of the optical device 100. For example, one or more of the first FAU 108a, the second FAU 108b, the first MLA 110a, the second MLA 110b, one or more of the lenses 112, the first array of beam steering elements 114a, the second array of beam steering elements 114b, one or more individual beam steering elements of the first array of beam steering elements 114a, or one or more individual beam steering elements of the second array of beam steering elements 114b may experience a change in state (e.g., a physical shift) due to a drift effect. Here, one or more of the elements from the set of elements can be adjusted so as to account for an impact of a drift effect. For example, one or more beam steering elements in the first array of beam steering elements 114a and/or one or more beam steering elements in the second array of beam steering elements 114b may be adjustable so as to influence coupling of optical beams among inputs and outputs of the optical device 100. In general, any element of the optical device 100 that provides active alignment (e.g., a beam steering element, a piezoelectric actuator, or the like) for the optical device 100 can be adjustable so as to influence coupling of optical beams among inputs and outputs of the optical device 100. Such adjustments can be used to account for the drift effect experienced among the set of elements of the optical device 100 (e.g., the set of elements including the first FAU 108a, the second FAU 108b, the first MLA 110a, the second MLA 110b, one or more lenses 112, the first array of beam steering elements 114a, the second array of beam steering elements 114b, one or more individual beam steering elements of the first array of beam steering elements 114a, one or more individual beam steering elements of the second array of beam steering elements 114b, or the like).

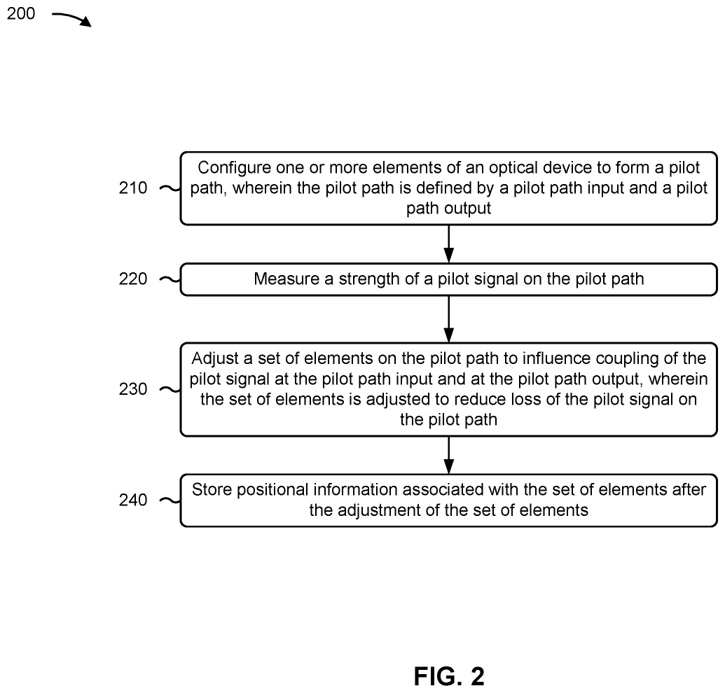

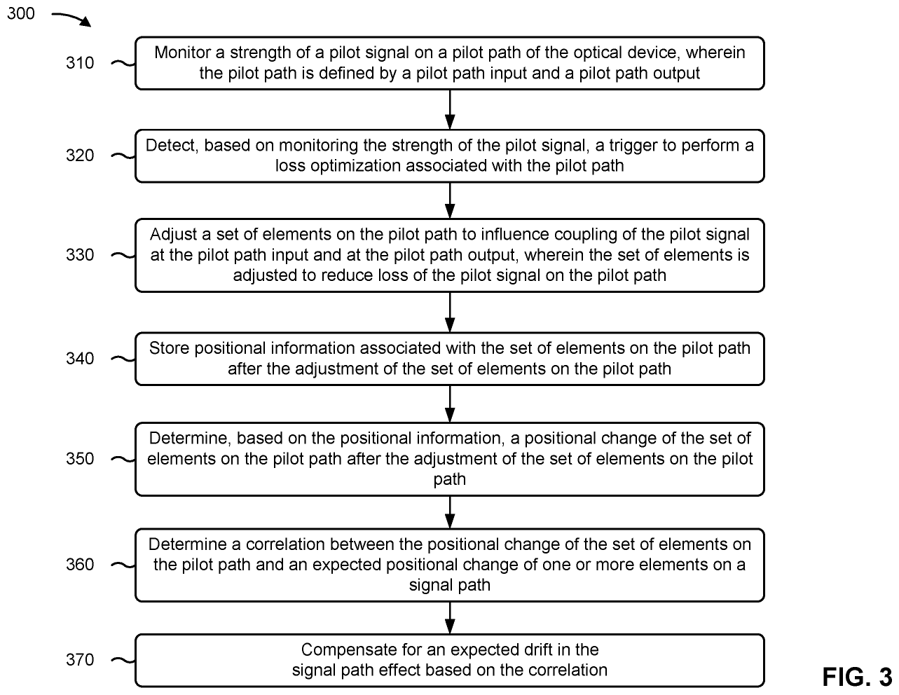

In some implementations, as noted above, a pilot path input 104i can be coupled to a pilot path output 104o to form a pilot path. Here, steering provided by a beam steering element in the first array of beam steering elements 114a and/or a beam steering element in the second array of beam steering elements 114b can be adjusted (e.g., from the original start of life calibration) as needed by optimizing light (e.g., strength of a pilot signal) coupled from the light source 106 to the photodiode 116 terminating the pilot path. In some implementations, the adjustment applied in association with optimizing the pilot path can be used as a basis for providing compensation for a set of signal paths (e.g., adjustment that provides compensation to each signal path in the set of signal paths). That is, the optical signal that traverses the pilot path can be monitored, and one or more elements (e.g., one or more beam steering elements) can be adjusted to optimize optical power on the pilot path. Here, the adjustment of the one or more elements on the pilot path can be used to determine an adjustment that compensates or accounts for a difference in a current state of the set of elements relative to a previous state of the set of elements such that an impact of a drift effect is compensated for one or more signal paths of the optical device 100. Thus, in some implementations, the controller 118 may apply an adjustment to a signal path to compensate for, for example, bulk optical angle shifts (which may be substantially equal for the signal paths and the pilot path). Here, if the pilot path and the signal path shift equally, then compensation applied to individual beam steering elements may provide perfect correction. In some implementations, adjustments to provide compensation for shifts of one or more elements of the optical device 100 can be determined using a closed loop control algorithm implemented on the controller 118. Additional details regarding the closed loop control algorithm are provided below with respect to FIGS. 2 and 3.

In some implementations, as noted above, the set of K pilot path inputs 104i and the set of L pilot path outputs 104o of the optical device 100 can be used to form multiple pilot paths, which may improve compensation (e.g., as compared to using a single pilot path). In one example, the optical device 100 may include two pilot path inputs 104i (e.g., K=2) and two pilot path outputs 104o (e.g., L=2), meaning that the optical device 100 has four possible pilot paths (e.g., 2²=4), with each pilot path input 104i having two possible pilot path outputs 104o. As another example, the optical device 100 may include three pilot path inputs 104i (e.g., K=3) and three pilot path outputs 104o (e.g., L=3), meaning that the optical device 100 has nine possible pilot paths (e.g., 3²=9), with each pilot path input 104i having three possible pilot path outputs 104o. As another example, the optical device 100 may include four pilot path inputs 104i (e.g., K=4) and four pilot path outputs 104o (e.g., L=4), meaning that the optical device 100 has sixteen possible pilot paths (e.g., 4²=16), with each pilot path input 104i having four possible pilot path outputs 104o. In some implementations, the use of multiple pilot paths provides a reference adjustment at multiple positions of each pilot path beam steering element such that angle shifts associated with a drift effect (e.g., an aging effect, a temperature effect, or the like) can be accurately calculated and corrected using closed loop control. Further, the use of multiple pilot paths provides redundancy for reliability (e.g., the closed loop function can persist even if one or more beam steering elements on a given pilot path fails to actuate). In some such implementations, locations of specific beam steering elements of the first array of beam steering elements 114a and/or locations of specific beam steering elements of the second array of beam steering elements 114b that are involved in the multiple pilot paths can be distributed across the first array of beam steering elements 114a and the second array of beam steering elements 114b, respectively, so as to improve performance with respect to compensation. Further, the positions of the K input pilot paths 104i may be spread around the FAU 108a to improve performance with respect to compensation. Similarly, the positions of the L output pilot paths 104o may be spread around the FAU 108b to improve performance with respect to compensation.

In some implementations, closed loop control provided by the controller 118 using one or more pilot paths can serve to compensate for drift effects, thereby reducing loss for optical signals traversing the optical device 100. The configuration of the optical device 100 also provides other advantages. For example, the optical device 100 may enable drift of individual beam steering elements of a given array of beam steering elements 114 to be compensated in the field (e.g., using half of a pilot path and another half of a signal path) in combination with an external light source and/or one or more external photodiodes. Further, in some implementations, the optical device 100 enables field recalibration of signal paths formed among the M signal inputs 102i and the N signal outputs 102o, as well as efficient calibration during manufacturing of the optical device 100.

As indicated above, FIG. 1 is provided as an example. Other examples may differ from what is described with regard to FIG. 1. The number and arrangement of elements shown in FIG. 1 are provided as an example. In practice, there may be additional elements, fewer elements, different elements, or differently arranged elements than those shown in FIG. 1. Furthermore, two or more elements shown in FIG. 1 may be implemented within a single element, or a single element shown in FIG. 1 may be implemented as multiple, distributed elements. Additionally, or alternatively, a set of elements (e.g., one or more elements) shown in FIG. 1 may perform one or more functions described as being performed by another set of elements shown in FIG. 1.

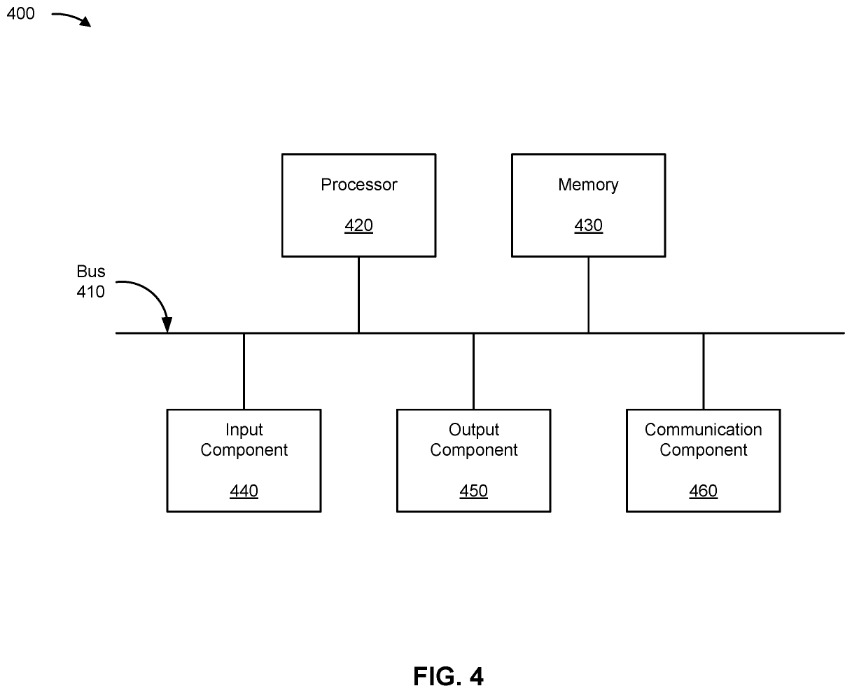

FIG. 2 is a flow chart illustrating an example process 200 associated with calibrating the optical device 100 described herein. In some implementations, one or more process blocks of FIG. 2 are performed by a controller (e.g., controller 118). Additionally, or alternatively, one or more process blocks of FIG. 2 may be performed by one or more components of device 400 shown in FIG. 4, such as processor 420, memory 430, input component 440, output component 450, and/or communication component 460.

As shown in FIG. 2, process 200 may include configuring one or more elements of the optical device to form a pilot path, wherein the pilot path is defined by a pilot path input and a pilot path output (block 210). For example, the controller 118 may configure one or more elements (e.g., one or more beam steering elements of the first array of beam steering elements 114a, one or more beam steering elements of the second array of beam steering elements 114b, or the like) of the optical device 100 to form a pilot path, wherein the pilot path is defined by a pilot path input 104i and a pilot path output 104o.

As further shown in FIG. 2, process 200 may include measuring a strength of a pilot signal on the pilot path (block 220). For example, the controller 118 may measure a strength of a pilot signal on the pilot path. In some implementations, the pilot signal may be provided on the pilot path by a light source 106 coupled to the pilot path input 104i.

In some implementations, the controller 118 receives an electrical signal from a photodiode 116 that terminates the pilot path. Here, a characteristic of the electrical signal (e.g., an amplitude) may indicate the strength of pilot signal. Thus, the controller 118 may determine the strength of the pilot signal based on the characteristic of the electrical signal.

As further shown in FIG. 2, process 200 may include adjusting a set of elements on the pilot path to influence coupling of the pilot signal at the pilot path input and at the pilot path output, wherein the set of elements is adjusted to reduce loss of the pilot signal on the pilot path (block 230). For example, the controller 118 may adjust a set of elements on the pilot path to influence coupling of the pilot signal at the pilot path input 104i and at the pilot path output 104o, wherein the set of elements is adjusted to reduce loss of the pilot signal on the pilot path.

In some implementations, the controller 118 stores or has access to information indicating an optimized (e.g., maximum) pilot signal strength. Here, if the strength of the pilot signal as measured by the controller 118 is less than the optimized pilot signal strength (or differs from the optimized pilot signal strength by more than a threshold), then the controller 118 adjusts the set of elements so as to increase the strength of the pilot signal. In some implementations, the controller 118 may adjust a given element in the set of elements with respect to one or more dimensions (e.g., one or more tilt angles with respect to one or more respective axes). Therefore, in some implementations, a given element (e.g., a given beam steering element in a given array of beam steering elements 114) may be adjusted in one or more dimensions in association with increasing or optimizing the strength of the pilot signal at the termination of the pilot path. In some implementations, the set of elements adjusted by the controller 118 may include one or more beam steering elements of the first array of beam steering elements 114a and/or one or more beam steering elements of the second array of beam steering elements 114b. In some implementations, the controller may perform multiple iterations of such measurement and adjustment (e.g., operations associated with blocks 210 and 220) so as to optimize the strength of the pilot signal as measured by the controller 118.

As further shown in FIG. 2, process 200 may include storing positional information associated with the set of elements after the adjustment of the set of elements (block 240). For example, the controller 118 may store positional information associated with the set of elements (e.g., beam steering elements of the arrays of beam steering elements 114) after the adjustment of the set of elements. In some implementations, the positional information includes information that indicates a position associated with the set of elements with respect to one or more dimensions. For example, the positional information associated with a given beam steering element of an array of beam steering elements 114 may include information indicating a set of tilt angles of the beam steering element at rest (e.g., when no voltage or a ground voltage is applied to the given beam steering element), with each tilt angle being with respect to a different axis about which the given beam steering element is tiltable. For example, the positional information may be associated with a voltage or voltages applied to a given beam steering element. As another example, the positional information may include information indicating a period and an orientation angle of a diffraction grating in a scenario in which an array of beam steering elements 114 comprises an array of diffractive beam steering elements (e.g., when the array of beam steering elements 114 is an LCOS array or another type of phased array device). In such a scenario, a diffraction grating pattern displayed on the array of beam steering elements 114 can be adjusted to steer optical beams incident thereon.

In some implementations, the controller 118 performs process 200 in association with calibration of the optical device. In some implementations, a state associated with the set of elements may be defined by the positional information associated with the set of elements (e.g., positional information for each element in the set of elements). In some implementations, a state associated with the set of elements after calibration may be referred to as an original state or a calibration state.

In some implementations, the controller 118 performs multiple iterations of the process 200, with each iteration being performed with respect to a different pilot path in a set of pilot paths. In some implementations, the controller 118 may perform the process 200 for a set of pilot paths for which a drift effect may be representative of the drift effect as experienced by the signal paths of the optical device 100.

Process 200 may include additional implementations, such as any single implementation or any combination of implementations described below and/or in connection with one or more other processes described elsewhere herein.

Although FIG. 2 shows example blocks of process 200, in some implementations, process 200 includes additional blocks, fewer blocks, different blocks, or differently arranged blocks than those depicted in FIG. 2. Additionally, or alternatively, two or more of the blocks of process 200 may be performed in parallel.

FIG. 3 is a flow chart illustrating an example process 300 associated with providing drift compensation for the optical device 100. In some implementations, one or more process blocks of FIG. 3 are performed by a controller (e.g., controller 118). Additionally, or alternatively, one or more process blocks of FIG. 3 may be performed by one or more components of device 400 shown in FIG. 4, such as processor 420, memory 430, input component 440, output component 450, and/or communication component 460.

As shown in FIG. 3, process 300 may include monitoring a strength of a pilot signal on a pilot path of the optical device, wherein the pilot path is defined by a pilot path input and a pilot path output (block 310). For example, the controller 118 may monitor a strength of a pilot signal on a pilot path of the optical device 100, wherein the pilot path is defined by a pilot path input 104i and a pilot path output 104o.

In some implementations, prior to performing the monitoring, the controller 118 may configure one or more elements (e.g., one or more beam steering elements of the first array of beam steering elements 114a, one or more beam steering elements of the second array of beam steering elements 114b, or the like) of the optical device 100 to form a pilot path.

In some implementations, the pilot signal provided on the pilot path by a light source 106 coupled to the pilot path input 104i. In some implementations, the controller 118 receives an electrical signal from a photodiode 116 that terminates the pilot path. Here, a characteristic of the electrical signal (e.g., an amplitude) may indicate the strength of pilot signal. Thus, the controller 118 may measure the strength of the pilot signal based on the characteristic of the electrical signal. In some implementations, the controller 118 may monitor the strength of the pilot signal by performing measurements of the strength of the pilot signal on a periodic basis or continuously over a period of time.

As further shown in FIG. 3, process 300 may include detecting, based on monitoring the strength of the pilot signal, a trigger to perform a loss optimization associated with the pilot path (block 320). For example, the controller 118 may detect, based on monitoring the strength of the pilot signal, a trigger to perform a loss optimization associated with the pilot path.

In some implementations, the trigger may include a determination that the strength of the pilot signal has decreased by a threshold amount (e.g., a 5% decrease from a previous measurement) or satisfies a threshold (e.g., is less than a pilot signal strength threshold). In some implementations, upon detecting such a trigger, the controller 118 may perform loss optimization associated with the pilot path (e.g., by adjusting a set of elements of the optical device 100, as described below).

As further shown in FIG. 3, process 300 may include adjusting a set of elements on the pilot path to influence coupling of the pilot signal at the pilot path input and at the pilot path output, wherein the set of elements is adjusted to reduce loss of the pilot signal on the pilot path (block 330). For example, the controller 118 may adjust a set of elements on the pilot path to influence coupling of the pilot signal at the pilot path input and at the pilot path output, wherein the set of elements is adjusted to reduce loss of the pilot signal on the pilot path. In some implementations, the set of elements may include, for example one or more beam steering elements (e.g., one or more beam steering elements of the first array of beam steering elements 114a and/or one or more beam steering elements of the second array of beam steering elements 114b).

In some implementations, the controller 118 stores or has access to information indicating an optimized (e.g., maximum) pilot signal strength. Here, upon detecting the trigger, the controller 118 may adjust the set of elements so as to increase the strength of the pilot signal. In some implementations, the controller 118 may adjust a given element in the set of elements with respect to one or more dimensions (e.g., one or more tilt angles with respect to one or more respective axes). Therefore, in some implementations, a given element (e.g., a given beam steering element in a given array of beam steering elements 114) may be adjusted in one or more dimensions in association with increasing or optimizing the strength of the pilot signal at the termination of the pilot path. In some implementations, the set of elements adjusted by the controller 118 may include one or more beam steering elements of the first array of beam steering elements 114a and/or one or more beam steering elements of the second array of beam steering elements 114b. In some implementations, the controller may perform multiple iterations of measurement and adjustment so as to increase or optimize the strength of the pilot signal.

As further shown in FIG. 3, process 300 may include storing positional information associated with the set of elements on the pilot path after the adjustment of the set of elements on the pilot path (block 340). For example, the controller 118 may store positional information associated with the set of elements on the pilot path after the adjustment of the set of elements on the pilot path.

In some implementations, the positional information includes information that indicates a position associated with the set of elements with respect to one or more dimensions. For example, the positional information associated with a given beam steering element of an array of beam steering elements 114 may include information indicating a set of tilt angles of the beam steering element at rest (e.g., when no voltage or a ground voltage is applied to the given beam steering element), with each tilt angle being with respect to a different axis about which the given beam steering element is tiltable. For example, the positional information may be associated with a voltage or voltages applied to a given beam steering element.

As further shown in FIG. 3, process 300 may include determining, based on the positional information, a positional change of the set of elements on the pilot path after the adjustment of the set of elements on the pilot path (block 350). For example, the controller 118 may determine, based on the positional information, a positional change of the set of elements on the pilot path after the adjustment of the set of elements on the pilot path. In some implementations, the controller 118 determines the positional change of the set of elements on the pilot path based on the positional information associated with the current state of the set of elements (e.g., after the adjustment by the controller 118) and positional information associated with a previous state associated with the set of elements (e.g., the original state, the calibration state, a state after a previous adjustment, or the like). In some implementations, the positional change associated with a given element (e.g., a given beam steering element of a given array of beam steering elements 114) may indicate an amount by which the position of the given element changed from the previous state (e.g., the original state, the calibration state, a state after a previous adjustment, or the like) to the current state.

As further shown in FIG. 3, process 300 may include determining a correlation between the positional change of the set of elements on the pilot path and an expected positional change of one or more elements on a signal path (block 360). For example, the controller 118 may determine a correlation between the positional change and an expected positional change of one or more elements on a signal path.

In some implementations, the controller 118 stores or has access to a drift model designed to model an impact of one or more drift effects (e.g., aging, temperature, or the like) expected to be experienced by one or more elements of the optical device 100. In some implementations, the drift model may receive an indication of a positional change of the one or more elements on the pilot path as an input, and may provide information associated with a correlation between the positional change of the set of elements on the pilot path and the expected positional change of one or more elements on a signal path as an output. Here, the correlation may indicate an expected impact of the one or more drift effects on the one or more elements on the signal path given the positional change applied to the set of elements on the pilot path. Thus, the correlation may indicate one or more adjustments to be applied to the one or more elements on the signal path.

In some implementations, the drift model may be designed to receive indications of positional changes of sets of elements on multiple pilot paths as input, and to provide information associated with a correlation between the positional changes of the sets of elements on the multiple pilot paths and an expected positional change of one or more elements on a signal path as an output. That is, in some implementations, the correlation may indicate an expected impact of the one or more drift effects on elements of a signal path given positional changes applied to sets of elements on multiple pilot paths. In this scenario, the correlation may indicate one or more adjustments to be applied to one or more elements on the signal path. In such a configuration, the drift model could be designed to provide unique correction of a given signal path based on, for example, a location of the given signal path relative to locations of pilot paths in an array of pilot paths.

Additionally, or alternatively, the drift model may be designed to receive information associated with a correlation between a positional change of a set of elements on a pilot path as input, and to provide information associated with a correlation between the positional changes of the set of elements on the pilot path and expected positional changes of one or more elements on multiple signal paths (e.g., all signal paths of the optical device 100) as an output. That is, in some implementations, the correlation may indicate an expected impact of the one or more drift effects on elements of multiple signal paths given the positional change applied to a set of elements on a pilot path. In this scenario, the correlation may indicate one or more adjustments to be applied to one or more elements on each of the multiple signal paths.

Additionally, or alternatively, the drift model may be designed to receive indications of positional changes of sets of elements on multiple pilot paths as input, and to provide information associated with a correlation between the positional changes of the sets of elements on the multiple pilot paths and expected positional changes of one or more elements on multiple signal paths (e.g., all signal paths of the optical device 100) as an output. That is, in some implementations, the correlation may indicate an expected impact of the one or more drift effects on elements of multiple signal paths given positional changes applied to sets of elements on multiple pilot paths. In this scenario, the correlation may indicate one or more adjustments to be applied to one or more elements on each of the multiple signal paths.

In some implementations, the drift model may be derived from design, simulation, and/or experimental data of positional changes associated with the set of elements obtained with optimizing a strength of a pilot signal on the pilot paths of the optical device 100.

In one example, the controller 118 may adjust a beam steering element of the first array of beam steering elements 114a and a beam steering element of the second array of beam steering elements 114b in association with optimizing a strength of a pilot signal on a pilot path, as described above. Here, a positional change determined based on these adjustments may be provided to a drift model, and the drift model may provide a correlation indicating an expected positional change of one or more elements on a signal path of the optical device 100 given the positional change applied in association with optimizing the strength of the pilot signal. Thus, the correlation may indicate an adjustment to be applied to one or more beam steering elements of the first array of beam steering elements 114a and/or the second array of beam steering elements 114b that define the signal path among the M signal inputs 102i and the N signal outputs 102o of the optical device 100.

As further shown in FIG. 3, process 300 may include compensating for an expected drift in the signal path based on the correlation (block 370). For example, the controller 118 may compensate for the expected drift in the signal path based on the correlation by adjusting one or more elements of the set of elements in the signal path (e.g., one or more beam steering elements of the first array of beam steering elements 114a and/or one or more beam steering elements of the second array of beam steering elements 114b that define signal paths) based at least in part on the correlation provided by the drift model. In some implementations, the compensation is applied to elements on one or more signal paths of the optical device 100. In this way compensation for the drift effect can be provided by closed loop control provided by the controller 118.

In some implementations, the controller 118 performs multiple (e.g., successive or concurrent) iterations of the process 300, with each iteration being performed with respect to a different pilot path or set of pilot paths. In some implementations, the controller 118 may perform continuous monitoring or may perform periodic monitoring associated with one or more pilot paths.

Process 300 may include additional implementations, such as any single implementation or any combination of implementations described below and/or in connection with one or more other processes described elsewhere herein.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

FIG. 4 is a diagram of example components of a device 400 associated with optical switch with closed loop feedback. The device 400 may correspond to the controller 118. In some implementations, the controller 118 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical device, comprising:
a set of M (M≥1) signal inputs;
a set of K (K≥1) pilot path inputs, wherein a light source is coupled to a pilot path input in the set of K pilot path inputs;
a set of N (N≥1) signal outputs;
a set of L (L≥1) pilot path outputs, wherein a pilot path output in the set of L pilot path outputs is coupled to the pilot path input to form a pilot path;
a set of elements, the set of elements being on the pilot path and on a set of signal paths formed among the set of M signal inputs and the set of N signal outputs,
wherein at least one element in the set of elements is adjustable to influence coupling of optical beams among inputs and outputs of the optical device;
a photodiode coupled to the pilot path output to convert a pilot signal on the pilot path output to an electrical signal; and
a controller to selectively adjust one or more elements of the set of elements based on a relationship between the electrical signal and the selective adjustment,
wherein the adjustment is to compensate for a difference in a current state associated with the set of elements relative to an original state associated with the set of elements.

2. The optical device of claim 1, wherein the light source is included in the optical device.

3. The optical device of claim 1, wherein the pilot signal is provided by the light source and does not carry data.

4. The optical device of claim 1, wherein the set of K pilot path inputs includes multiple pilot path inputs and the set of L pilot path outputs includes multiple pilot path outputs such that the set of K pilot path inputs and the set of L pilot path outputs are configurable to form multiple pilot paths, and the controller is to selectively adjust the one or more elements based on pilot signals associated with the multiple pilot paths.

5. The optical device of claim 4, wherein the multiple pilot path inputs and the multiple pilot path outputs are configured such that the multiple pilot paths are distributed across an array of beam steering elements of the optical device.

6. The optical device of claim 1, wherein the selective adjustment of the one or more elements comprises an adjustment of one or more beam steering elements in an array of beam steering elements.

7. The optical device of claim 1, wherein the selective adjustment is to provide compensation for an impact of the difference in the current state relative to the original state on each signal path in the set of the signal paths.

8. The optical device of claim 1, wherein the one or more elements include at least one of microelectromechanical systems (MEMS) device, a liquid crystal on silicon (LCOS) device, a piezoelectric device, or a transducer.

9. An optical device, comprising:
a set of M (M≥1) signal inputs;
a set of K (K≥1) pilot path inputs, wherein a light source is coupled to a pilot path input in the set of K pilot path inputs;
a set of N (N≥1) signal outputs;
a set of L (L≥1) pilot path outputs, wherein a pilot path output in the set of L pilot path outputs is coupled to the pilot path input to form a pilot path;
a set of elements on the pilot path and on a set of signal paths formed among the set of M signal inputs and the set of N signal outputs;
a photodiode coupled to the pilot path output; and
a controller to provide compensation for the set of signal paths based at least in part on a pilot signal that traverses the pilot path, wherein the compensation is to account for a difference in a current state of the set of elements relative to a previous state of the set of elements.

10. The optical device of claim 9, wherein the controller, to provide the compensation, is to adjust one or more elements of the set of elements.

11. The optical device of claim 9, wherein the light source is external to the optical device.

12. The optical device of claim 9, wherein the pilot signal is received from the light source and does not carry data.

13. The optical device of claim 9, wherein the set of K pilot path inputs and the set of L pilot path outputs are configurable to form multiple pilot paths, and the controller is to provide the compensation based on pilot signals associated with the multiple pilot paths.

14. The optical device of claim 13, wherein the multiple pilot paths are distributed across an array of beam steering elements of the optical device.

15. The optical device of claim 9, wherein, to provide the compensation, the controller is to adjust one or more beam steering elements in an array of beam steering elements.

16. The optical device of claim 9, wherein the one or more elements include at least one of microelectromechanical systems (MEMS) device, a liquid crystal on silicon (LCOS) device, a piezoelectric device, or a transducer.

17. The optical device of claim 9, wherein the optical device is an M×N optical switch.

18. A method, comprising:
monitoring, by a controller of an optical device, a strength of a pilot signal on a pilot path of the optical device, wherein the pilot path is defined by a pilot path input and a pilot path output;
detecting, by the controller and based on monitoring the strength of the pilot signal, a trigger to perform a loss optimization associated with the pilot path;
adjusting, by the controller, a set of elements on the pilot path to influence coupling of the pilot signal at the pilot path input and at the pilot path output, wherein the set of elements is adjusted to reduce loss of the pilot signal on the pilot path;
storing, by the controller, positional information associated with the set of elements on the pilot path after the adjustment of the set of elements on the pilot path;
determining, by the controller and based on the positional information, a positional change of the set of elements on the pilot path after the adjustment of the set of elements on the pilot path;
determining, by the controller, a correlation between the positional change of the set of elements on the pilot path and an expected positional change of one or more elements on a signal path; and
compensating, by the controller, for the expected drift effect based on the correlation.

19. The method of claim 18, wherein the pilot signal does not carry data.

20. The method of claim 18, wherein adjusting the set of elements comprises adjusting one or more beam steering elements in an array of beam steering elements.
